(19) United States
(12) Patent Application Publication
(10) Pub. No.: US 2002/0019898 A1
(43) Pub. Date: Feb. 14, 2002

(54) Microprocessor, semiconductor module and data processing system

(75) Inventors: Isamu Hayashi, Funabashi (JP); Masao Naruse, Kokubunji (JP)

Correspondence Address: Miles and Stockbridge P.C., 1751 Pinnacle Drive, Suite 500, Mclean, VA, 22102-3833, US

(73) Assignee: Hitachi, Ltd.

(21) Appl. No.: 09/897,902

(22) Filed: Jul. 5, 2001

(30) Foreign Application Priority Data
Jul. 27, 2000 (JP) 2000-226707

(51) Int. Cl. G06F 13/00

(52) U.S. Cl. 710/110

(57) ABSTRACT

It is possible to provide a data-processing system wherein a single device such as a microprocessor is capable of selectively making an access to one of high-speed and low-speed devices each operating synchronously with a clock signal peculiar to the device, and clock control can be executed with ease in an operation to switch the external device to be accessed from one to another. Clock signals each having a required frequency are provided individually through separate clock wires to high-speed and low-speed devices to be accessed by a microprocessor. Since control is executed to switch a synchronous clock signal of an external bus interface control circuit embedded in the microprocessor in accordance with an external device or an address area being accessed by the microprocessor, there is exhibited an effect of easy clock control in an operation to switch the external device to be accessed from one to another without the need to switch the clock signal itself which is to be supplied to the external device.

### BACKGROUND OF THE INVENTION

In general, the present invention relates to a bus-access control technology for making accesses to a plurality of devices with the operating clock frequencies thereof much different from each other. More particularly, the present invention relates to an effective technology applied to a data-processing system comprising a bus master device, a bus slave device and a microprocessor which has a central processing unit and is capable of controlling an external bus.

In recent years, the operating frequencies of a microprocessor and a semiconductor device such as a memory have been increasing. Typically, a microprocessor includes a central processing unit (abbreviated hereafter to merely a CPU) for executing instructions and a bus-state controller for making an access to an external bus. The bus-state controller controls accesses to an external bus connected to external devices such as a memory and an input/output circuit, which are each mapped onto an area in an address space external to the microprocessor. An operating frequency of control executed by the bus-state controller on accesses to an external bus can be selected from a variety of values in accordance with initial setting of a control register. In general, due to some properties peculiar to accesses to an external bus, the accesses to the external bus is controlled synchronously with a clock frequency lower than the operating frequency of the CPU. Now that improvement of processing performance of the system as a whole is aimed at, however, the fact is that applications of low-speed semiconductor devices presented from old times are occasionally excluded from consideration. Assume a case in which the external bus of a microprocessor is connected to both an SDRAM (Synchronous Dynamic Random-Access Memory) capable of operating synchronously with a clock signal with a frequency of 150 MHz and an input/output device used as a pointing device. The pointing device can be assumed to operate synchronously with a clock signal having a frequency of about 20 MHz. In this case, the operating frequency of external accesses controlled by the bus-state controller is probably determined with the clock frequency of the high-speed external device taken as a reference. That is because it is unrealistic to drive the high-speed external device at the operating clock frequency set for the low-speed external device such as the input/output device.

If the low-speed external device is forcibly driven to operate at a high speed, however, we can presume that a normal operation cannot be expected due to effects of input capacitance of the device, stray capacitance and wiring resistance in many cases. This is because the low-speed external device is manufactured in a fabrication process not assuming a high-speed operation. As a result, the use of a low-speed external device, which has been utilized for a long time and has gaining much trust from the user, must be abandoned in some cases. In consequence, it is feared that the user of semiconductor devices must bear a heavy load such as the need to develop a new high-speed external semiconductor device having a function equivalent to the abandoned one and a narrowing range of selection of usable semiconductor devices.

After completion of the present invention, disclosed documents were surveyed and, as a result of the survey, Japanese Patent Laid-open No. Hei 5(1993)-341872 was identified. It is an object of the technology disclosed in this document to allow a clock signal with a frequency optimum for hardware characteristics to be supplied to an external data-processing unit whenever required without carrying out processing by execution of software. In accordance with the technology, there is provided a data-processing apparatus with a configuration which:

includes a clock generator capable of generating an operating clock signal having a variable frequency;

initially sets data representing the operating clock signal's frequency optimum for an external data-processing apparatus in a control register;

identifies the external data-processing apparatus to be accessed from an address output by a central processing unit employed in the data-processing apparatus;

selects the data representing the operating clock signal's frequency optimum for the external data-processing apparatus from the control register; and

outputs a clock signal with a frequency optimum for the external data-processing apparatus in accordance with the selected data to the external data-processing apparatus as the operating clock signal.

In brief, with this disclosed technology, the frequency of a clock signal shared by an external device is controlled in accordance with the access address. In accordance with this technology, however, in order to change the clock frequency, it is necessary to consider not only the internal operating state of the data-processing apparatus, but also the operating state of the external device. This is because, when the frequency of the clock signal is changed during the operation of the external device, a malfunction may occur due to an undesirable change in signal-clock phase.

### SUMMARY OF THE INVENTION

It is thus an object of the present invention addressing the problems described above to provide a microprocessor capable of controlling accesses to a plurality of external devices at a frequency varying from device to device and capable of controlling the clock signal when switching an access with ease.

It is another object of the present invention to provide a data-processing apparatus comprising a central device such as a microprocessor, high-speed devices and low-speed devices wherein the microprocessor by itself is capable of making accesses to a selected one of the high-speed devices or a selected one of the low-speed devices synchronously with a clock signal peculiar to the selected high-speed or low-speed device capable of controlling the clock signal when switching an access with ease.

The above and other objects as well as novel features of the present invention will become more apparent from a study of this specification with reference to accompanying diagrams.

An outline of representatives of the present invention disclosed in this specification is described briefly as follows.

1: In accordance with an aspect of the present invention, there is provided a microprocessor comprising a central processing unit (CPU) for executing instructions and an external-bus-interface control circuit for controlling an external bus on the basis of execution of instructions by the central processing unit, the CPU and the external-bus-interface control circuit being built on a single semiconductor chip. The external-bus-interface control circuit is capable of selecting one of a plurality of external-device select signals that corresponds to an external-access address and activating the selected external-device select signal. The microprocessor also includes a clock-switching control circuit for controlling an operation to switch a synchronous clock signal of the external-bus-interface control circuit in accordance with the external-device select signal activated by the external-bus-interface control circuit. In an embodiment wherein the external-device select signals are implemented as 2 signals, namely, a first external-device select signal and a second external-device select signal, the external-bus-interface control circuit is thus capable of selecting either the first external-device select signal or the second external-device select signal that corresponds to an external-access address and activating either the first external-device select signal or the second external-device select signal. The clock-switching control circuit controls an operation to switch a synchronous clock signal of the external-bus-interface control circuit to a first clock signal when the first external-device select signal is selected and to a second clock signal when the second external-device select signal is selected.

In accordance with the means described above, it is thus necessary to individually provide the first clock signal all the time to a first external device to be selected by the first external-device select signal and the second clock signal all the time to a second external device to be selected by the second external-device select signal. When the microprocessor makes an access to the first external device, the external-bus-interface control circuit embedded in the microprocessor needs to execute control to switch the synchronous clock signal of the external-bus-interface control circuit to the first clock signal. When the microprocessor makes an access to the second external device, on the other hand, the external-bus-interface control circuit embedded in the microprocessor needs to execute control to switch the synchronous clock signal of the external-bus-interface control circuit to the second clock signal. Thus, the clock signal itself supplied to each of the external devices does not have to be changed, making it easy to control the clock signal in an operation to switch an external device from one to another.

The first and second clock signals can be generated by a clock-pulse generator also embedded in the microprocessor. In this case, it is nice to provide the microprocessor with clock output pins for supplying the first and second clock signals generated by the clock-pulse generators at the same time to respectively outside the semiconductor chip.

In order to prevent a malfunction from occurring in the CPU or a circuit controlled by the CPU in an operation to switch the synchronous clock signal of the external-bus-interface control circuit, the clock-switching control circuit must request the CPU to suspend execution of instructions upon activation of a selected external-device select signal. It is then nice to switch the synchronous clock signal after an acknowledgment of the request for stopping of the instruction execution has been received.

In order to prevent a malfunction of the external-bus-interface control circuit from occurring right after an operation to switch the synchronous clock signal of the external-bus-interface control circuit, the external-bus-interface control circuit needs to switch the synchronous clock signal with a timing synchronized to periods of the second clock signal.

2: While the external-bus-interface control circuit is controlling an access to a low-speed external device, the CPU waits for the access to the low-speed external device to be completed. In the mean time, when the CPU makes an attempt to continue subsequent processing of data at a high speed, a phenomenon such as a pipeline stall may occur. In this case or from the standpoint of power-consumption reduction and maintenance data-processing continuity or from another point of view, reduction of the operating speed of the CPU is worth considering. From these points of view, the clock-switching control circuit employed in the microprocessor executes control to switch the synchronous clock signal of the external-bus-interface control circuit to the first clock signal as well as switch a synchronous clock signal of the CPU to a third clock signal in response to activation of the first external-device select signal, and executes control to switch the synchronous clock signal of the external-bus-interface control circuit to the second clock signal as well as switch the synchronous clock signal of the CPU to a fourth clock signal in response to activation of the second external-device select signal.

The first to fourth clock signals may be generated by a clock-pulse generator embedded in the microprocessor. In this case, the clock-pulse generator generates the first clock signal and the second clock signal with a period equal to a predetermined multiple of the period of the first clock signal wherein the predetermined multiple is generally referred to hereafter as a frequency-division ratio. In addition, the clock-pulse generator generates the third clock signal and the fourth clock signal with a period equal to another predetermined multiple of the period of the third clock signal wherein the other predetermined multiple is generally referred to as another frequency-division ratio. The frequencies of the third and fourth clock signals are each at least equal to that of the first clock signal. Furthermore, it is nice to provide the microprocessor with clock output pins for supplying the first and second clock signals generated by the clock-pulse generator in parallel to respectively the first and second external devices outside the semiconductor chip.

3: In accordance with another aspect of the present invention, there is provided a semiconductor module comprising a processor chip and a memory chip operating synchronously with a first clock signal wherein:

the processor chip and the memory chip are provided on a module substrate having a plurality of external-connection electrodes and a plurality of wiring layers;

the microprocessor chip has a clock-pulse generator for generating the first clock signal and a second clock signal having a frequency lower than that of the first clock signal and for supplying the first and second clock signals in parallel to components external to the microprocessor chip;

the microprocessor chip is capable of making an access to the memory chip synchronously with the first clock signal; and

the microprocessor chip is capable of making an external access to any of the components external to the microprocessor chip through one of the external-connection electrodes synchronously with the second clock signal.

The semiconductor module is mounted on a mother board through external-connection pins. With the semiconductor module mounted on a mother board, the processor chip controls accesses to low-speed devices on the mother board. As described earlier, the first and second signals need to be individually supplied to the memory chip and the low-speed devices mounted on the mother board respectively all the time. When making an access to the memory chip, the processor chip needs to execute control to switch a synchronous clock signal of the access operation to the first clock signal. When making an access to a low-speed device mounted on the mother board, on the other hand, the processor chip needs to execute control to switch the synchronous clock signal of the access operation to the second clock signal. As a result, the first clock signal itself supplied to the memory chip and the second clock signal itself supplied to a low-speed device mounted on the mother board do not have to be changed, making it easy to control the clock signal in an operation to switch the device to be accessed from the memory chip to the low-speed device or vice versa.

The microprocessor chip comprises a CPU for executing instructions, an external-bus-interface control circuit for executing control of an external bus on the basis of execution of an instruction by the CPU and a clock-switching control circuit, the CPU, the external-bus-interface control circuit and the clock-switching control circuit being built in a single chip. In accordance with an external-access address, the external-bus-interface control circuit is capable of activating a memory-chip select signal for selecting the memory chip or a device select signal for selecting a device connected to the microprocessor chip through one of the external-connection electrodes. The clock-switching control circuit executes control to switch a synchronous clock signal of the external-bus-interface control circuit to a first clock signal in response to activation of the memory-chip select signal, or executes control to switch the synchronous clock signal of the external-bus-interface control circuit to a second clock signal in response to activation of the device select signal

4: In accordance with a further aspect of the present invention, there is provided a data-processing system comprising:

first and second clock wires for propagating respectively a first clock signal and a second clock signal with a frequency lower than the first clock signal;

a first device operating synchronously with the first clock signal propagating through the first clock wire;

a second device operating synchronously with the second clock signal; and

a third device capable of controlling accesses to the first device synchronously with the first clock signal and capable of controlling accesses to the second device synchronously with the second clock signal,

wherein the first and second clock wires as well as the first to third devices are provided on a mounting board.

In this data-processing system, it is thus necessary to individually provide the first clock signal all the time to the first device such as a high-speed memory and the second clock signal all the time to the second device such as a low-speed IO (input/output) circuit. The third device such as a microprocessor executes control to switch a synchronous clock signal of an access operation to the first clock signal when making an access to the first device, or executes control to switch the synchronous clock signal of the access operation to the second clock signal when making an access to the second device. As a result, the first clock signal itself supplied to the first device such as a high-speed memory and the second clock signal itself supplied to the second device such as a low-speed IO circuit do not have to be changed, making it easy to control the clock signal in an operation to switch the device to be accessed from the first device to the second device or vice versa.

The mounting board can be a single circuit board. As a typical alternative, the mounting board may comprise:

a first circuit board including a first board wire connected to the second device; and

a second circuit board including a second board wire connected to the first board wire and said second board wire is connected to said first device and a third device.

The third device is a microprocessor comprising a central processing unit (CPU) for executing instructions, an external-bus-interface control circuit for controlling an external bus on the basis of execution of instructions by the central processing, the CPU, the external-bus-interface control circuit and the clock-switching control circuit being built on a single semiconductor chip. In accordance with an external-access address, the external-bus-interface control circuit is capable of activating a first external-device select signal for selecting the first device or a second external-device select signal for selecting the second device. The clock-switching control circuit executes control to switch a synchronous clock signal of the external-bus-interface control circuit to a first clock signal in response to activation of the first external-device select signal, or executes control to switch the synchronous clock signal of the external-bus-interface control circuit to a second clock signal in response to activation of the second external-device select signal.

The first and second clock signals may be generated by a clock-pulse generator embedded in the third device. In this case, the clock-pulse generator generates the first clock signal and the second clock signal with a period equal to a predetermined multiple of the period of the first clock signal wherein the predetermined multiple is generally referred to as a frequency-division ratio. Furthermore, it is nice to provide the microprocessor with clock output pins for supplying the first and second clock signals generated by the clock-pulse generator at the same time to respectively outside the semiconductor chip.

### BRIEF DESCRIPTION OF THE DRAWINGS

FIG. 1 is a block diagram showing a typical data-processing system provided by the present invention;

FIG. 2 is a block diagram showing a reference system controlling an operation to switch an external clock signal's frequency itself as an example to be compared with the data-processing system shown in FIG. 1;

FIG. 3 is a block diagram showing a typical microprocessor provided by the present invention;

FIG. 4 is a logic-circuit diagram showing a typical CPG (Clock Pulse Generator);

FIG. 5 is a block diagram showing a typical bus controller and a typical clock-switching control circuit;

FIG. 6 is a block diagram showing details of an area select control unit and the clock-switching control circuit by focusing on selection of a frequency of a synchronous clock signal;

FIG. 7 is timing charts of timings to switch a clock signal in the clock-switching control circuit;

FIG. 8 is a flowchart representing an entire clock-frequency-switching operation carried out by an external-bus-interface control circuit in response to an operation to switch an external-access address area;

FIG. 9 is a block diagram showing another typical bus controller and another typical clock-switching control circuit;

FIG. 10 is a block diagram showing details of the clock-switching control circuit shown in FIG. 9;

FIG. 11 is a block diagram showing the data-processing system of FIG. 1 by focusing on the configuration of a mounting board; and

FIG. 12 is a diagram showing a cross section of a multi-layer wiring structure of a multi-layer wiring board.

### PREFERRED EMBODIMENTS OF THE INVENTION

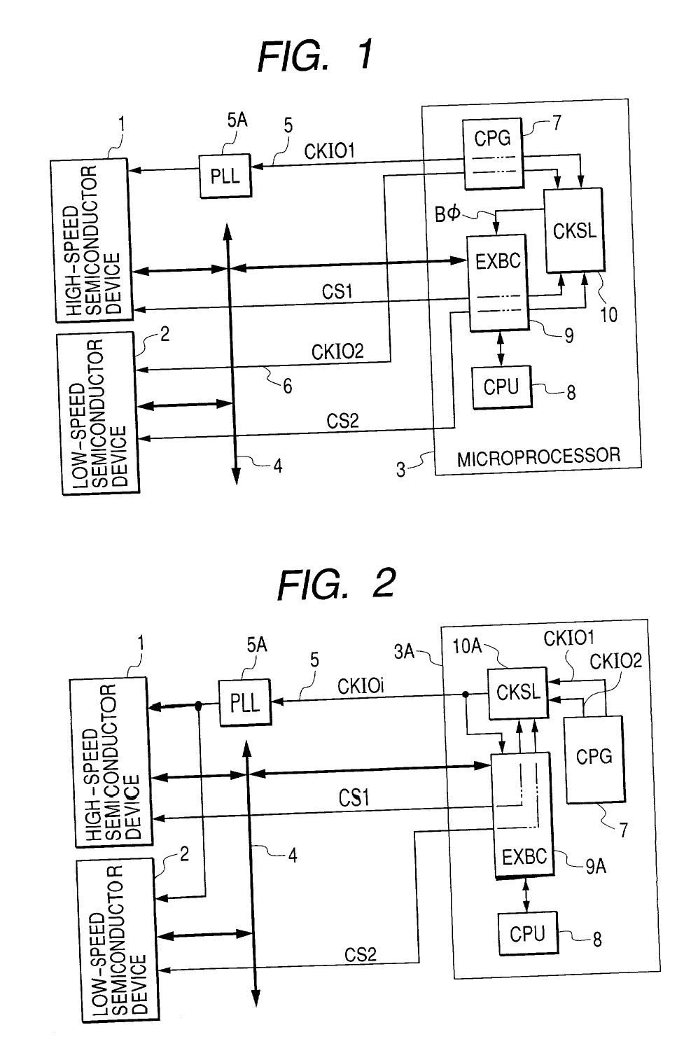

FIG. 1 is a block diagram showing a typical data-processing system provided by the present invention. The data-processing system shown in the figure comprises representative semiconductor circuits including a high-speed semiconductor device (first device) 1, a low-speed semiconductor device (second device) 2 and a microprocessor (third device) 3 which are connected to each other by a bus 4. The bus 4 propagates data, an address and an access control signal. A representative example of the high-speed semiconductor device 1 is a high-speed memory such as an SDRAM operating synchronously with a high-frequency clock signal (first clock signal) CKIO1 having a typical frequency of 150 MHz. On the other hand, a representative example of the low-speed semiconductor device 2 is an IO device connected to man-machine interface equipment such as a pointing device operating synchronously with a relatively-low-frequency clock signal (second clock signal) CKIO2 having a typical frequency of 20 MHz. The high-frequency clock signal CKIO1 is supplied to the high-speed semiconductor device 1 from the microprocessor 3 through a first clock wire 5. On the other hand, the low-frequency clock signal CKIO2 is supplied to the low-speed semiconductor device 2 from the microprocessor 3 through a second clock wire 6 provided separately from the first wire 5. A PLL (phase locked loop) circuit 5A is provided on the first wire 5 at a location close to the high-speed semiconductor device 1 as shown in FIG. 1. The PLL circuit 5A operates at a frequency equal to an equimultiple of an input/output frequency. The PLL circuit 5A is capable of compensating the clock-synchronous operation of the high-speed semiconductor device 1 for variations in CKIO1 frequency.

The microprocessor 3 has a clock-pulse generator (CPG) 7 for generating other internal synchronous clock signals in addition to the high-frequency clock signal CKIO1 and the low-frequency clock signal CKIO2. The microprocessor 3 is capable of controlling accesses to the high-speed semiconductor device 1 synchronously with the high-frequency clock signal CKIO1 and accesses to the low-speed semiconductor device 2 synchronously with the low-frequency clock signal CKIO2. This access control is executed by an external-bus interface control circuit (EXBC) 9 for controlling an external bus, being based on execution of instructions by a central processing unit (CPU) 8. The external-bus interface control circuit 9 is capable of operating the high-speed semiconductor device 1 or selecting the high-speed semiconductor device 1 as a device to operate by activating a chip select signal (first external-device select signal) CS1 when an address assigned to the high-speed semiconductor device 1 is used as an external-access address. In addition, the external-bus interface control circuit 9 is also capable of operating the low-speed semiconductor device 2 or selecting the low-speed semiconductor device 2 as a device to operate by activating a chip select signal (second external-device select signal) CS2 when an address assigned to the low-speed semiconductor device 2 is used as an external-access address. When the high-speed semiconductor device 1 is operating synchronously with the high-frequency clocksignal CKIO1, the external-bus interface control circuit 9 is operated also synchronously with the high-frequency clock signal CKIO1. When the low-speed semiconductor device 2 is operating synchronously with the low-frequency clock signal CKIO2, on the other hand, the external-bus interface control circuit 9 is operated also synchronously with the high-frequency clock signal CKIO2. A clock-switching control circuit (CKSL) 10 is used to switch a synchronous clock signal Bφ of the external-bus interface control circuit 9 from the high-frequency clock signal CKIO1 to the low-frequency clock signal CKIO2 and vice versa. To be more specific, the clock-switching control circuit 10 executes control to switch the synchronous clock signal Bφ of the external-bus interface control circuit 9 to the high-frequency clock signal CKIO1 in response to activation of the chip select signal CS1. On the other hand, the clock-switching control circuit 10 executes control to switch the synchronous clock signal Bφ of the external-bus interface control circuit 9 to the low-frequency clock signal CKIO2 in response to activation of the chip select signal CS2.

In accordance with the data-processing system shown in FIG. 1, the high-frequency clock signal CKIO1 and the low-frequency clock signal CKIO2 need to be supplied all the time to respectively the high-speed semiconductor device 1 and the low-speed semiconductor device 2, which are activated or selected to operate by the chip select signal CS1 and the chip select signal CS2 respectively. When the microprocessor 3 makes an access to the high-speed semiconductor device 1 by activating the chip select signal CS1, the clock-switching control circuit 10 needs to execute control to switch the synchronous clock signal Bφ of the external-bus interface control circuit 9 to the high-frequency clock signal CKIO1. When the microprocessor 3 makes an access to the low-speed semiconductor device 2 by activating the chip select signal CS2, on the other hand, the clock-switching control circuit 10 needs to execute control to switch the synchronous clock signal Bφ of the external-bus interface control circuit 9 to the low-frequency clock signal CKIO2. As a result, the first clock signal CKIO1 itself supplied to the first device 1 and the second clock signal CKIO2 itself supplied to the second device 2 do not have to be changed, making it easy to control the clock signal in an operation to switch the device to be accessed from the first device 1 to the second device 2 or vice versa.

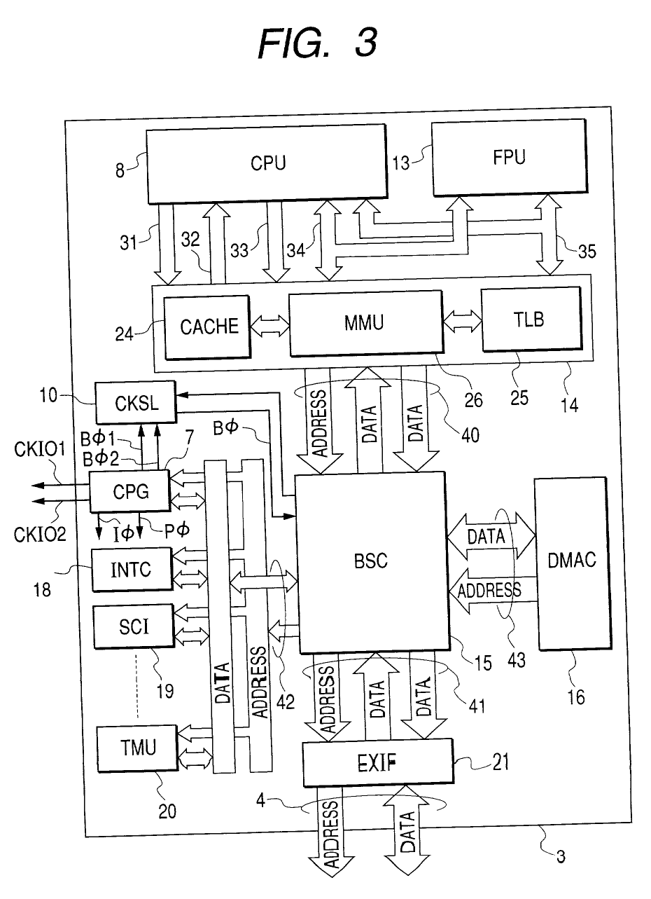

FIG. 2 is a block diagram showing a reference system controlling an operation to switch an CKIOi external clock signal's frequency itself as an example to be compared with the data-processing system shown in FIG. 1. In the reference system shown in FIG. 2, the external clock signal CKIOi is supplied to both the high-speed semiconductor device 1 and the low-speed semiconductor device 2 as a clock signal common to the devices. In this case, a clock-switching control circuit (CKSL) 10A selects either one of the high-frequency clock signal CKIO1 and the low-frequency clock signal CKIO2, which are generated by the clock pulse generator 7, and outputs the selected clock signal as the external clock signal CKIOi. To be more specific, the clock-switching control circuit (CKSL) 10A executes control to switch the external clock signal CKIOi to the high-frequency clock signal CKIO1 output by the clock-pulse generator 7 in response to activation of the chip select signal CS1. On the other hand, the clock-switching control circuit (CKSL) 10A executes control to switch the external clock signal CKIOi to the low-frequency clock signal CKIO2 output by the clock-pulse generator 7 in response to activation of the chip select signal CS2. An external-bus interface control circuit (EXBC) 9A controls bus accesses to the high-speed semiconductor device 1 and the low-speed semiconductor device 2 by using the external clock signal CKIOi as a synchronous clock signal. When the external clock signal CKIOi is switched from the high-frequency clock signal CKIO1 to the low-frequency clock signal CKIO2 or vice versa in the reference system shown in FIG. 2, a malfunction may occur unless the operations of both the high-speed semiconductor device 1 and the low-speed semiconductor device 2 are suspended. Assume for example that a microprocessor 3A makes an access to the low-speed semiconductor device 2 after completing an access to the high-speed semiconductor device 1. In this case, the external clock signal CKIOi supplied to the high-speed semiconductor device 1 is also switched to the frequency of the low-frequency clock signal CKIO2 for the low-speed semiconductor device 2. Thus, even after the access made by the microprocessor 3A is completed, the external clock signal CKIOi common to the high-speed semiconductor device 1 and the low-speed semiconductor device 2 cannot be switched to the frequency of the low-frequency clock signal CKIO2 if the high-speed semiconductor device 1 continues its operation even after the access made by the microprocessor 3A is completed. This is because the external clock signal CKIOi common to the high-speed semiconductor device 1 and the low-speed semiconductor device 2 can be switched to the frequency of the low-frequency clock signal CKIO2 only after the operation of the high-speed semiconductor device 1 is completed. Thus, in order to switch the external clock signal CKIOi common to the high-speed semiconductor device 1 and the low-speed semiconductor device 2 to the frequency of the high-frequency clock signal CKIO1 or the low-frequency clock signal CKIO2 in the reference system shown in FIG. 2, a judgment on an access address area formed by the microprocessor 3A is not sufficient by itself. That is, it is necessary to determine whether the operations of all external devices have been completed or to execute control to forcibly terminate the operations. In the data-processing system shown in FIG. 1, on the other hand, there is no danger of a malfunction's occurrence even if the control to determine whether the operations of all external devices have been completed or to forcibly terminate the operations is not executed in clock switching.

A typical microprocessor that can be used in the data-processing system shown in FIG. 1 is explained as follows. FIG. 3 is a block diagram showing a typical microprocessor 3 provided by the present invention. The microprocessor 3 shown in the figure is created on a semiconductor substrate made of typically single-crystal silicon by using, for example, a commonly known technology of fabricating semiconductor integrated circuits. As shown in the figure, the microprocessor 3 typically comprises a central processing unit (CPU) 8, a floating-point processing unit (FPU) 13, an internal memory unit 14, a bus-state controller (BSC) 15, a direct-memory-access controller (DMAC) 16, a clock-pulse generator (CPG) 7, an interrupt controller (INTC) 18, a serial-communication interface circuit (SCI) 19, a timer counter (TMU) 20 and an external-bus interface circuit 21. The internal memory unit 14 comprises a cache memory (CACHE) 24, an address-translation lookup buffer (TLB) 25 and a memory management unit (MMU) 26.

The CPU 8 uses 32-bit addresses to support a logical-address space of 4 gigabytes. As is shown in none of the figures, the CPU 8 has general registers, an ALU (arithmetic logic unit), a set of control registers including a program counter and an instruction control unit which is used for fetching an instruction, decoding a fetched instruction, controlling a procedure of executing a decoded instruction and controlling instruction-related processing. The CPU 8 outputs an instruction address to an instruction-address bus 31 in order to fetch an instruction, and reads in the instruction through an instruction bus 32. In addition, the CPU 8 supplies a data address to the internal memory unit 14 through a data-address bus 33 in order to load data from the internal memory unit 14 to the CPU 8 or store data from the CPU 8 to the internal memory unit 14. The floating-point unit (FPU) 13 does not have an addressing function. That is, the CPU 8 carries out an addressing function on behalf of the floating-point unit (FPU) 13. The CPU 8 loads and stores data for processing carried out by the floating-point unit (FPU) 13 to and from the internal memory unit 14 through data buses 34 and 35 respectively.

The CPU 8 fetches an instruction from a main memory external to the microprocessor 3 or the cache memory 24, and carries out data processing in accordance with a result of decoding of the instruction by the instruction control unit. It should be noted that the main memory is not shown in the figure. The floating-point unit (FPU) 13 carries out floating-point processing on data loaded from a memory by the addressing function executed by the CPU 8, and stores a result of the floating-point processing in a memory by using the addressing function executed by the CPU 8 or loads the result into a register in the CPU 8 through the data bus 35.

Viewed from the microprocessor 3, the logical-address space is divided into units each referred to as a logical page. The logical-address space appears conceptually to the microprocessor 3 as a virtual memory. A location in the virtual memory is indicated by a logical address. A logical address specified in a computer program to indicate a location in the virtual memory is translated by the memory management unit (MMU) 26 into a physical address of a logical page. The memory management unit (MMU) 26 manages the address-translation lookup buffer (TLB) 25 and resorts to the address-translation lookup buffer (TLB) 25 in translation of a logical address into a physical address. The address-translation lookup buffer (TLB) 25 is an associative memory comprising TLB entries each used for storing a relation between a physical address and a logical address. The memory management unit (MMU) 26 translates a logical address output by the CPU 8 into a physical address by referring to the address-translation lookup buffer (TLB) 25. In the event of a TLB miss wherein a logical address being translated is not cataloged in the address-translation lookup buffer (TLB) 25, a TLB entry for the logical address is imported from an address-translation lookup table (or a page table) stored in the main memory not shown in the figure by way of the memory management unit (MMU) 26. The address-translation lookup buffer (TLB) 25 is typically a multi-way associative cache memory. The memory management unit (MMU) 26 stores an exception code indicating a cause of an exception in an exception register not shown in the figure, and transmits a notification signal not shown in the figure to the CPU 8 to inform the CPU of the occurrence of the exception. A variety of exceptions including the TLB miss can occur during translation of a logical address to a physical address. The CPU 8 carries out predetermined exception handling by referring to the exception code set in the exception register. As an alternative, predetermined hardware directly carries out the exception handling without using the exception register.

The cache memory 24 is a multi-way associative memory. Typically, the cache memory 24 comprises a 4-way set associative cache memory unit and a control unit. A portion of a logical address is used as an index to the cache memory unit, and a physical address is stored in a tag unit's entry associated with the index. The physical address stored in the tag unit's entry associated with the index indicated by the portion of the logical address is compared with a physical address obtained as a result of translation of the logical address by using the address-translation lookup buffer (TLB) 25 to determine a cache miss or a cache hit. In the event of a cache miss wherein data or an instruction being accessed is not stored in the cache memory unit of the cache memory 24, the data or the instruction is imported from the main memory not shown in the figure and stored in the cache memory 24 as a new entry.

After data-transfer control conditions are set by the CPU 8 in the DMA (Direct Memory Access) controller 16, the DMA controller 16 controls transfers of data from and to an external device in accordance with the data-transfer control conditions in response to requests for DMA transfers.

The bus-state controller 15 is connected to the internal memory unit 14 by an internal bus 40, connected to an external-bus interface circuit 21 by an external-interface bus 41, connected the clock-pulse generator (CPG) 7, the interrupt controller (INTC) 18, the serial-communication interface (SCI) circuit 19 and the timer counter TMU 20 by a peripheral bus 42, and connected to the DMA controller 16 by a DMA bus 43. The bus-state controller 15 executes various kinds of control including control of a bus access through the external bus 4 such as control of an access to the main memory necessary in replacing an entry in the internal memory unit 14 in the event of a TLB miss or an entry in the cache memory 24 in the event of a cache miss, control of a device access to an address area excluded from the cache copying, control of a transfer of data to or from an external device by using the DMA controller 16, control of an access to a peripheral circuit through the peripheral bus 42, wait control, area-select control and memory-interface control.

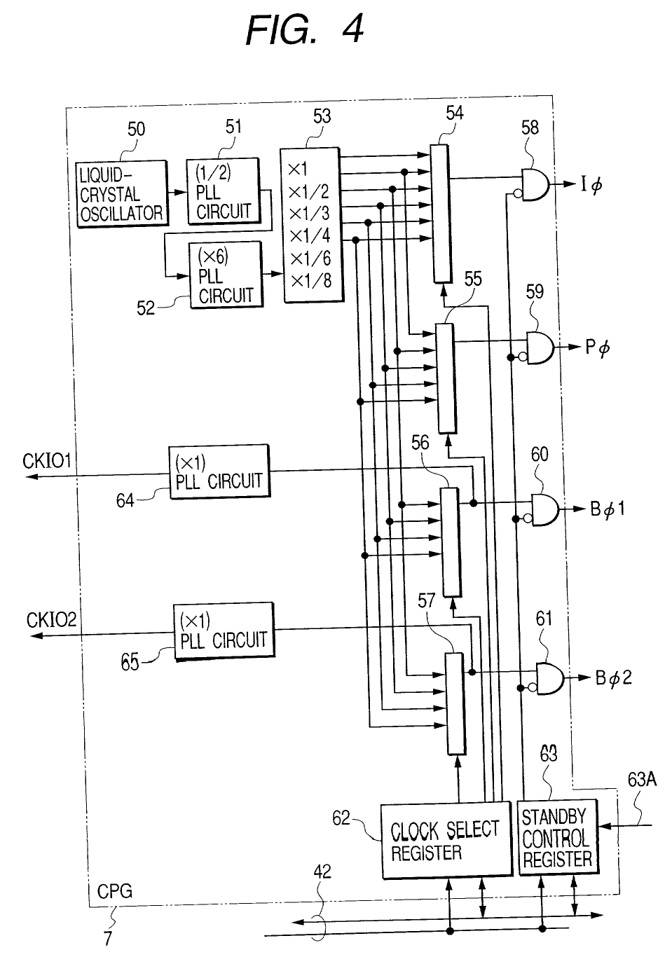

FIG. 4 is a logic-circuit diagram showing a typical configuration of the CPG (Clock Pulse Generator) 7. The frequency of a clock signal generated by a crystal-oscillation circuit 50 is divided by 2 by a PLL circuit 51 and then multiplied by 6 by a PLL circuit 52 provided at a later stage. The frequency of a signal output by the PLL circuit 52 is multiplied by 1, ½, ⅓, ¼, ⅙ and ⅛ in a frequency-division circuit 53 to generate clock signals with different frequencies. Selectors 54 to 57 each select one of the clock signals frequencies different from each other and supply selected signals to AND gates 58 to 61 respectively. The AND gates 58 to 61 generate an internal clock signal Iφ, a peripheral clock signal Pφ, a bus clock signal Bφ1 and a bus clock signal Bφ2 respectively, which are supplied to internal components inside the microprocessor 3. The selectors 54 to 57 each select a clock signal in accordance with select data stored in a clock select register 62. In addition to a clock signal, each of the AND gates 58 to 61 also receives a control bit from a standby control register 63. To put it in detail, with the control bit reset to a logical value of 0, the AND gates 58 to 61 are enabled to generate the internal clock signal Iφ, the peripheral clock signal Pφ, the bus clock signal Bφ1 and the bus clock signal Bφ2 respectively. With the control bit set to a logical value of 1, on the other hand, the AND gates 58 to 61 resets the internal clock signal Iφ, the peripheral clock signal Pφ, the bus clock signal Bφ1 and the bus clock signal Bφ2 respectively to a logical value of 0, suspending their changes. The CPU 8 is capable of controlling to read out and write data from and into the clock-select register 62 and the standby control register 63. The control bit stored in the standby control register 63 can be cleared to a logic value of 0 by a standby end signal 63A. A clock signal output by the selector 56 is supplied to also a PLL circuit 64 to be forwarded as the high-frequency clock signal CKIO1 mentioned earlier. By the same token, a clock signal output by the selector 57 is supplied to also a PLL circuit 65 to be forwarded as the low-frequency clock signal CKIO2 mentioned earlier.

The internal clock signal Iφ is used as a synchronous-operation clock signal of the CPU 8, the floating-point unit (FPU) 13 and the internal-memory unit 14, which are employed in the microprocessor 3. The Pφ is used as a synchronous-operation clock signal of peripheral circuits such as the clock-pulse generator (CPG) 7, the interrupt controller (INTC) 18, the serial-communication interface (SCI) circuit 19 and the timer counter TMU 20 as well as a synchronous-operation signal of the DMAC 16. The bus clock signal Bφ1 and the bus clock signal Bφ2 are used as a synchronous-operation clock signal Bφ in the bus-state controller 15 during an access to an external device through the external bus 4.

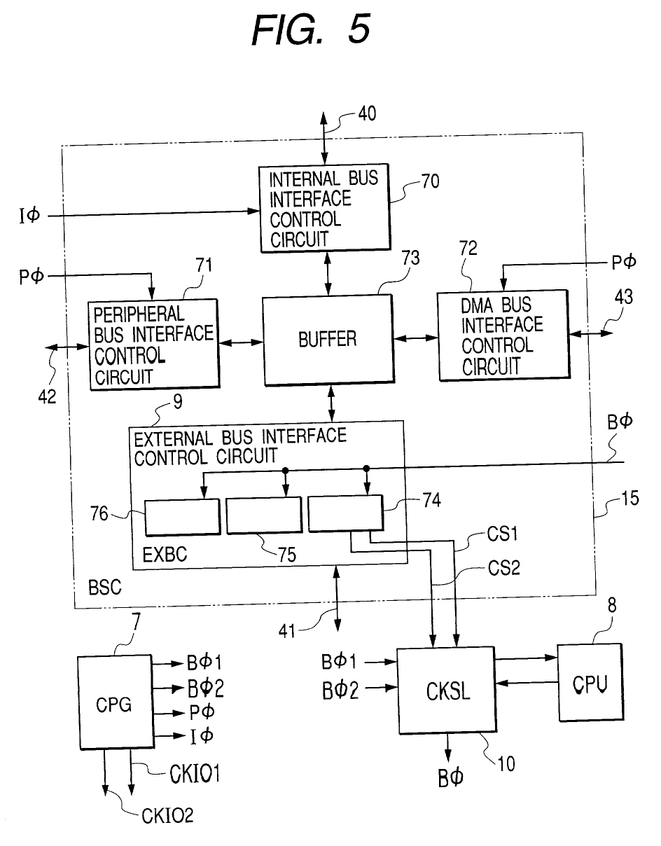

FIG. 5 is a diagram showing details of the bus-state controller 15. The bus-state controller 15 must exchange data, addresses and control signals with circuits having synchronous-operation clock frequencies different from each other through the internal bus 40, the external-interface bus 41, the peripheral bus 42 and the DMA bus 43. From the operation-clock-signal point of view, the bus-state controller 15 comprises an internal-bus-interface control circuit 70 connected to the internal bus 40, a peripheral-interface control circuit 71 connected to the peripheral bus 42, a DMA-bus-interface control circuit 71 connected to the DMA bus 43, an external-bus-interface control circuit (EXBC) 9 connected to the external-interface bus 41 and a buffer 73. The internal-bus-interface control circuit 70 operates synchronously with the internal clock signal Iφ, the peripheral-bus-interface control circuit 71 and the DMA-bus-interface control circuit 72 operate synchronously with the peripheral clock signal Pφ whereas the external-bus-interface control circuit 9 operates synchronously with the bus clock signal Bφ.

The external-bus-interface control circuit 9 has an area-select control unit 74, a memory control unit 75 and a wait control unit 76. The area select control unit 74 has an area specification register programmable to specify one of a plurality of address areas in the external memory space. A chip select signal is assigned to each specified address area. The area select control unit 74 executes control so that, when an external-access address included in an address area is detected, a chip select signal assigned to the address area is set at a select level. The memory control unit 75 has a function for outputting a memory-access control signal unique to each address area. The memory control unit 75 outputs a memory-access control signal associated with a chip's address area specified by the area select control unit 74. The wait control unit 76 executes control to inserts a wait state into a cycle making an access to an address area onto which a low-speed memory device is mapped.

FIG. 5 shows chip select signals CS1 and CS2 as representatives of chip select signals generated by the area select control unit 74. As explained earlier by referring to FIG. 1, the chip select signal CS1 and the chip select signal CS2 are output to chips external to the microprocessor 3 through of course the bus 41. In actuality, the chip select signal CS1 and the chip select signal CS2 are also supplied to the clock-switching control circuit 10 embedded in the microprocessor 3. The chip select signal CS1 and the chip select signal CS2 are used in the clock-switching control circuit 10 to select the bus clock signal Bφ1 or Bφ2 as the bus clock signal Bφ.

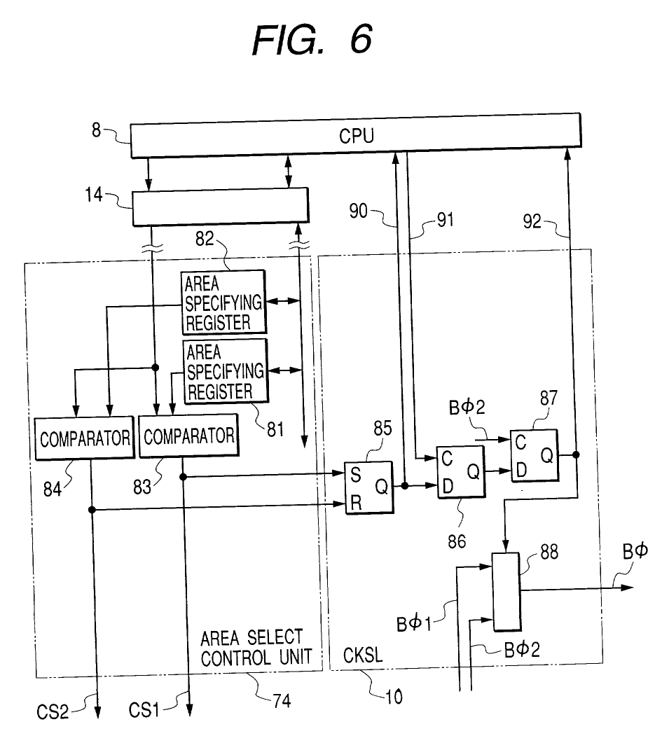

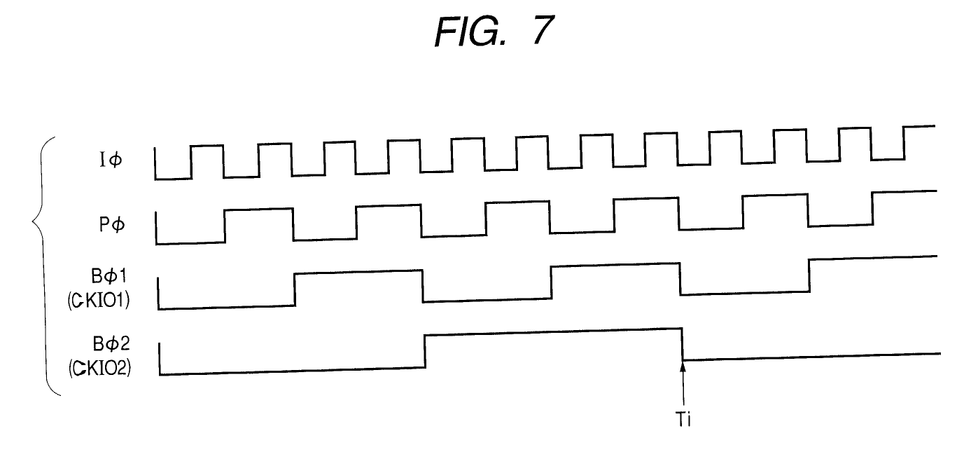

FIG. 6 is a block diagram showing details of the area select control unit 74 and the clock-switching control circuit 10 by focusing on selection of a frequency of the synchronous clock signal Bφ. In the figure, reference numerals 81 and 82 each denote an area-specification register shown as a representative. The CPU 8 specifies an address area. The area-specification register 81 is used for specifying an address area onto which the high-speed semiconductor device 1 is mapped. On the other hand, the area-specification register 82 is used for specifying an address area onto which the low-speed semiconductor device 2 is mapped. A comparator 83 compares an address area specified in the area-specification register 81 with a predetermined number of high-order bits of an access address. If they match each other, the comparator 83 sets the chip select signal CS1 into a high-level pulse. By the same token, a comparator 84 compares an address area specified in the area-specification register 82 with a predetermined number of high-order bits of an access address. If they match each other, the comparator 84 sets the chip select signal CS2 into a high-level pulse. The clock-switching control circuit 10 has a set and reset-type flip-flop 85, D-type flip-flops 86 and 87 and a clock selector 88. The set and reset-type flip-flop 85 has a set terminal S for receiving the chip select signal CS1 and a reset terminal R for receiving the chip select signal CS2. The chip select signal CS1 and the chip select signal CS2 drive the set and reset-type flip-flop 85 to output a signal 90 to an output terminal Q thereof. The signal 90 is set at a logic value of 1 indicating that the chip select state is switched from the low-speed semiconductor device 2 to the high-speed semiconductor device 1. On the other hand, the signal 90 is reset to a logic value of 0 indicating that the chip select state is switched from the high-speed semiconductor device 1 to the device 0. On the rising or falling edge of the signal 90, the CPU 8 is requested to suspend execution of instructions. As requested, the CPU 8 completes execution of an instruction being executed and then terminates execution of subsequent instructions. When execution of instructions is terminated, the CPU 8 outputs a pulse as a signal 91. The D-type flip-flop 86 has a data input terminal D for receiving the signal 90 and a clock terminal C for receiving the pulse signal 91. Thus, the D-type flip-flop 86 latches the signal 90 synchronously with a change in the pulse signal 91. As a result, when the chip select state is switched from the low-speed semiconductor device 2 to the high-speed semiconductor device 1, causing the CPU 8 to suspend execution of instructions, the D-type flip-flop 86 latches a logic value of 1. When the chip select state is switched from the high-speed semiconductor device 1 to the low-speed semiconductor device 2, causing the CPU 8 to suspend execution of instructions, on the other hand, the D-type flip-flop 86 latches a logic value of 0. The output of the D-type flip-flop 86 is latched in the D-type flip-flop 87 synchronously with the falling edge of the bus clock signal Bφ2. A signal 92 output by the D-type flip-flop 87 is supplied to the clock selector 88 and the CPU 8. When the signal 92 is set at a logic value of 1, the clock selector 88 selects the bus clock signal Bφ1 as the bus clock signal Bφ. In this case, the external-bus interface control circuit 9 operates synchronously with the bus clock signal Bφ1 shared by the high-speed semiconductor device 1 selected as a target of an external-bus access. When the signal 92 is set at a logic value of 0, on the other hand, the clock selector 88 selects the bus clock signal Bφ2 as the bus clock signal Bφ. In this case, the external-bus interface control circuit 9 operates synchronously with the bus clock signal Bφ2 shared by the low-speed semiconductor device 2 selected as a target of an external-bus access. In this way, a timing of a switching operation to select either the bus clock signal Bφ1 or Bφ2 as the bus clock signal Bφ is determined by the signal 92 output by the D-type flip-flop 87. Since the D-type flip-flop 87 changes the signal 92 synchronously with the period of the bus clock signal Bφ2 having a lowest frequency as shown in FIG. 7, it is possible to avoid fear of a malfunction's occurrence due to a change of the synchronization clock period to an extremely short one in the course of operation.

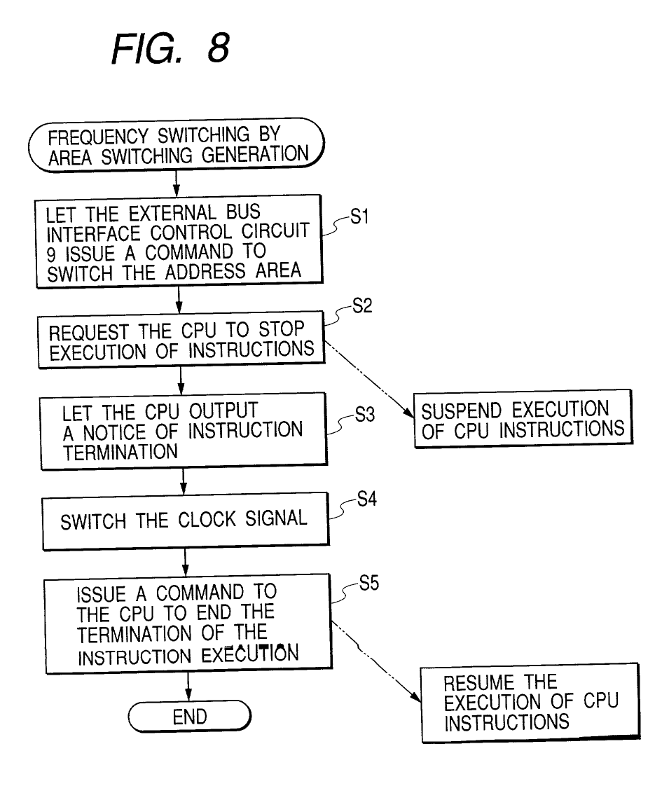

FIG. 8 is a flowchart representing an entire clock-frequency-switching operation carried out by the external-bus interface control circuit 9 in response to an operation to switch an external-access address area. As shown in the figure, the flowchart begins with a step S1 at which the external-bus interface control circuit 9 issues a command to switch an address area. At the next step S2, the signal 90 requests the CPU 8 to suspend execution of instructions. As requested, the CPU 8 suspends execution of instructions, and informs the clock-switching control circuit 10 of the instruction-execution termination at the step S3. Then, at the next step S4, the clock signal is switched synchronously with the bus clock signal Bφ2. Later on, at the step S5, the CPU 8 resumes the execution of instructions.

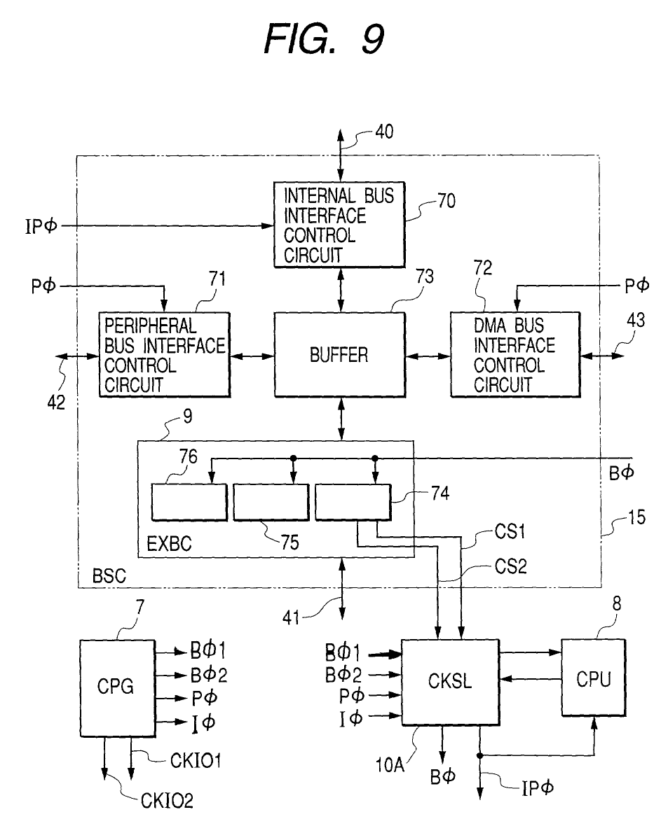

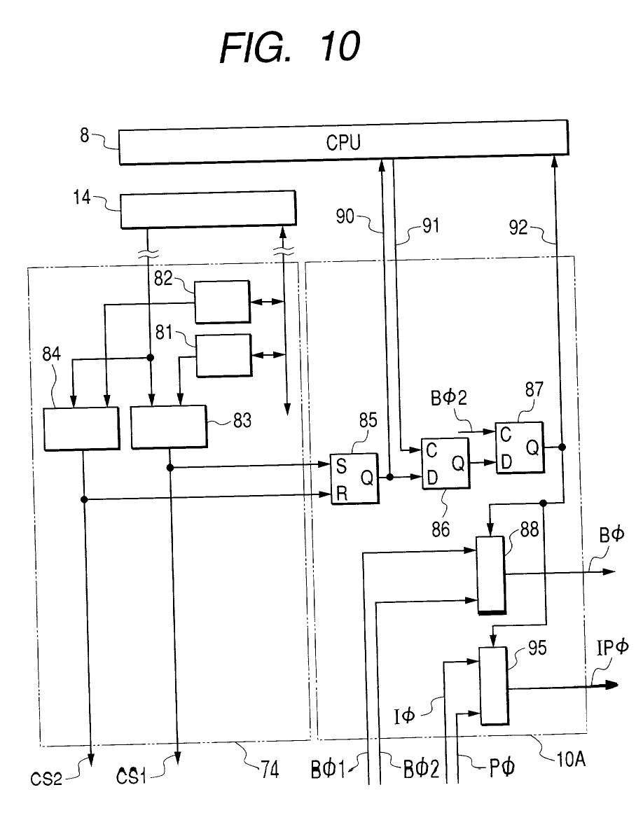

Another typical clock control circuit is explained as follows. FIG. 9 is a block diagram showing another typical bus controller and another typical clock-switching control circuit (CKSL) 10A, which are capable of switching the frequency of the synchronous clock signal of the CPU 8. FIG. 10 is a block diagram showing details of the clock-switching control circuit (CKSL) 10A shown in FIG. 9.

The clock-switching control circuit (CKSL) 10A shown in FIG. 9 is different from the clock-switching control circuit 10 shown in FIG. 5 in that the clock-switching control circuit (CKSL) 10A also inputs the peripheral clock signal Pφ and the internal clock signal Iφ in addition to the bus clock signal Bφ1 and the bus clock signal Bφ2, selecting either the internal clock signal Iφ or Pφ in accordance with the states of the chip select signal CS1 and the chip select signal CS2. The selected internal clock signal Iφ or the selected peripheral clock signal Pφ is supplied to the CPU 8 as a synchronous clock signal IPφ. The synchronous clock signal IPφ is also supplied to the internal-bus-interface control circuit 70 employed in the bus-state controller 15.

FIG. 10 is a block diagram showing details of the clock-switching control circuit (CKSL) 10A shown in FIG. 9. The clock-switching control circuit (CKSL) 10A shown in FIG. 10 is different from the clock-switching control circuit 10 shown in FIG. 6 in that the clock-switching control circuit (CKSL) 10A includes a clock selector 95 for selecting the internal clock signal Iφ or the peripheral clock signal Pφ in accordance with the value of the signal 92 and outputting the selected clock signal as the synchronous clock signal IPφ. In the embodiment shown in FIG. 10, with the clock selector 88 selecting the bus clock signal Bφ1 (CKIO1) supplied to the high-speed semiconductor device 1 as the bus clock signal Bφ, another clock selector 95 is put in a state to select the internal clock signal Iφ as the synchronous clock signal IPφ. With the clock selector 88 selecting the bus clock signal Bφ2 (CKIO2) supplied to the low-speed semiconductor device 2 as the bus clock signal Bφ, on the other hand, the other clock selector 95 is put in a state to select the peripheral clock signal Pφ as the synchronous clock signal IPφ. Thus, when the microprocessor 3 makes an access to the high-speed semiconductor device 1, the CPU 8 also operates at a high speed synchronously with the internal clock signal Iφ. When the microprocessor 3 makes an access to the low-speed semiconductor device 2, on the other hand, the CPU 8 also operates at a relatively low speed synchronously with the peripheral clock signal Pφ. In this way, when waiting for an access to the low-speed semiconductor device 2 to be completed, the CPU 8 consumes a small power. In addition, even if the CPU 8 continues its operation while waiting for the completion of an access to the low-speed semiconductor device 2, a problem such as a pipeline stall can be avoided, making it easy to implement continuity of the processing operation. This is because the CPU 8 carries out its operation at a low speed.

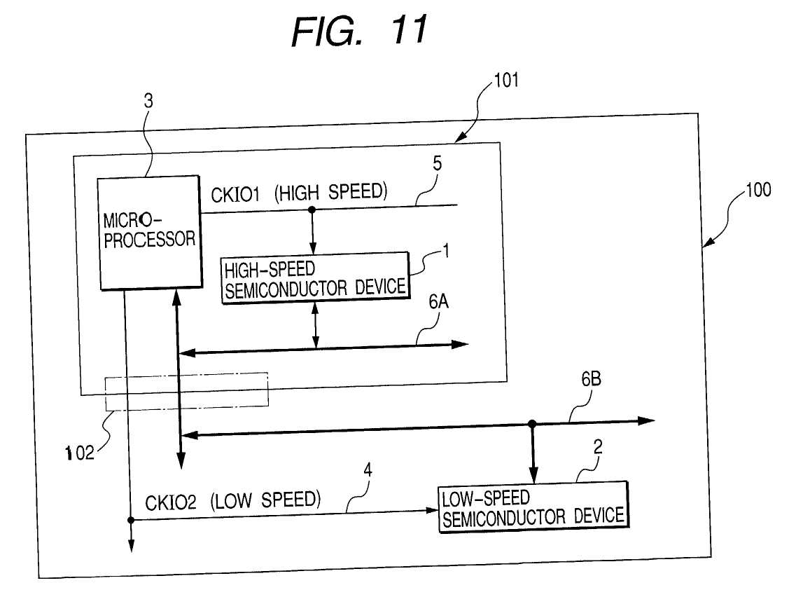

FIG. 11 is a block diagram showing the data-processing system of FIG. 1 by focusing on the configuration of amounting board. In FIG. 11, reference numeral 100 denotes a mother board (first circuit board) and reference numeral 101 denotes a daughter board (second circuit board) mounted on the mother board 100. The daughter board 101 includes a bus 6A and a clock wire 5 as a second board wire. The bus 6A and the clock wire 5 connect the microprocessor 3 to the high-speed semiconductor device 1. On the other hand, the mother board 100 includes a bus 6B and a clock wire 4 as a first board wire. The bus 6B and the clock wire 4 connect the microprocessor 3 to the low-speed semiconductor device 2. The bus 6A of the daughter board 101 is connected to the bus 6B of the mother board 100 and the wire 4 is connected to the microprocessor 3 by a socket connector 102 which is conceptually shown in the figure.

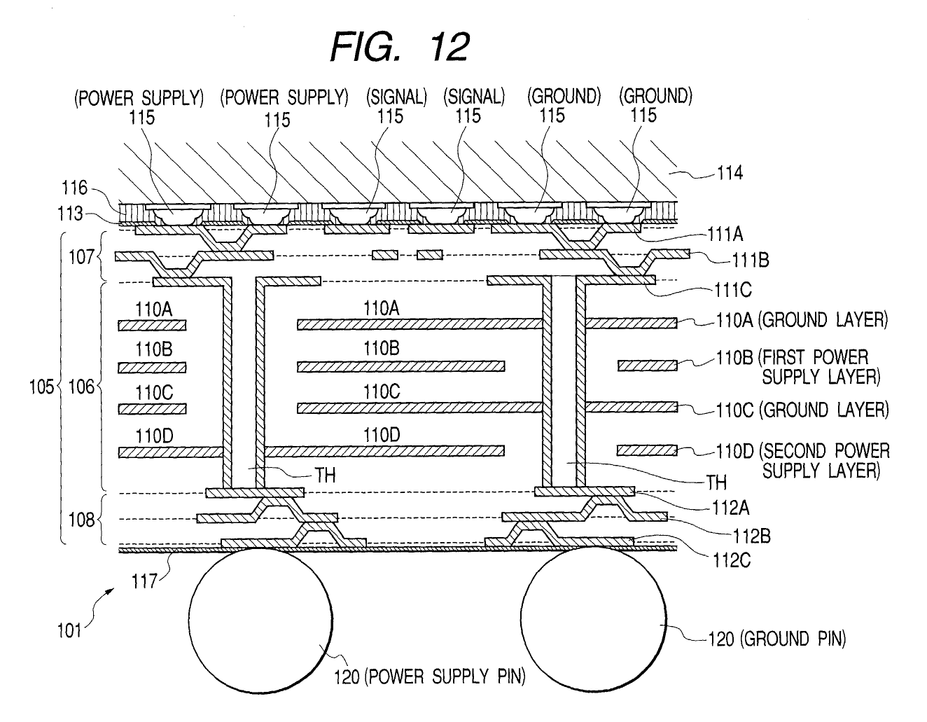

The daughter board 101 shown in FIG. 11 can also be implemented as a semiconductor module using a module board having a multi-layer wiring structure. FIG. 12 is a diagram showing a cross section of a multi-layer wiring structure of a multi-layer wiring board 105. As shown in the figure, the multi-layer wiring board 105 has a core layer or a base layer 106, a build-up layer 107 superposed on the upper surface of the core layer 106 and a build-up layer 108 superposed on the lower surface of the core layer 106. The core layer 106 has a plurality of wiring layers. The build-up layer 107 has as many wiring layers as the build-up layer 108 has. Thus, the build-up layer 107 and the build-up layer 108 are created on the upper surface and the lower surface of the core layer 106 respectively, forming a structure symmetrical with respect to the core layer 106. In such a symmetrical structure, a camber caused by heat dissipated by the daughter board 101 can be effectively avoided.

The core layer 106 typically comprises 4 copper-wiring layers 110A to 110D stacked on each other and separated from each other by glass epoxy resin. The build-up layer 107 on the upper surface of the core layer 106 comprises three copper-wiring layers 111A to 111C stacked on each other and separated from each other by glass epoxy resin. By the same token, the build-up layer 108 on the lower surface of the core layer 106 comprises three copper-wiring layers 112A to 112C stacked on each other and separated from each other by glass epoxy resin. The wiring layers are properly connected to each other if necessary by through holes TH.

Except through holes selectively provided on the wiring layers 110A to 110D, the entire surface of each of the wiring layers 110A to 110D is covered uniformly by a power-supply-wire pattern or a ground-wire pattern which is created as a Beta pattern forming a semiconductor layer. Such a structure is designed by consideration to make the value of equivalent static capacitance between a signal pattern and a power-supply pattern or a ground pattern large and uniform over all circuits.

Except mounting pads used for mounting a bare chip 114 of predetermined semiconductor circuits such as the microprocessor 3 on the top layer of the build-up layer 107, the top layer is covered by an insulation layer (or a protection layer) 113 such as a solder resist layer. A bump electrode 115 made of gold or aluminum (Au) of the bare chip 114 is electrically connected to a mounting pad by the wiring layer 111A through an anisotropic conductive film 116 and fixed on the surface of the build-up layer 107 by the anisotropic conductive film 116.

Except external-connection electrodes 120, the surface of the build-up layer 108 is covered by an insulation layer 117 such as a resist layer. On portions of the wiring layer 112C, which are exposed from the insulation layer 117, the external-connection electrodes 120 are created.

The build-up layer 107 and the build-up layer 108 are created by repeatedly carrying out processes of attaching epoxy resin on the core layer 106, forming through holes at predetermined locations and forming a wiring pattern made of copper on the upper surfaces thereof. To put it in detail, the build-up layer 107 and the build-up layer 108 are created as follows. First of all, the core layer 106 is submerged in epoxy resin liquid to form first epoxy-resin layers on the upper and lower surfaces of the core layer 106. Through holes are then formed at portions on the epoxy-resin layers, which correspond to wiring connection locations, by adoption of an etching technique using a proper etching mask. After that, a metallic film made of copper is created to form the wiring layer 111C or the wiring layer 112A. The wiring layer 111C or the wiring layer 112A is formed also by adoption of the etching technique. By repeatedly carrying out the process described above one after another, the wiring layer 111B to the wiring layer 111A or the wiring layer 112B to the wiring layer 112C can be created. Then, by selectively creating the insulation layer 113 and the insulation layer 117 from typically a solder-resist layer, the build-up layer 107 and the build-up layer 108 are formed.

Assume that a camber is generated on a module due to an effect of a thermal stress developed during a process to mount the module. Such thermal stress is caused by a difference in characteristic between the core layer 106 and the build-up layer 107 or the build-up layer 108. In this case, the build-up layer 107 or the build-up layer 108 may be peeled off from the core layer 106, resulting in an internal-wire breakage. As described earlier by referring to FIG. 12, in a board with the build-up layer 107 created on the upper surface of the core layer 106 and the build-up layer 108 created on the lower surface of the core layer 106, thermal characteristics of the upper surface are the same as those of the lower surface. Thus, the effect of thermal stress can be reduced to a minimum. As a result, the possibility of the peeling-off phenomenon of layers and the wire breakage can also be decreased, making it possible to implement a highly reliable multi-chip module.

The present invention discovered by the inventor have been exemplified so far in concrete terms by explaining preferred embodiments. It should be noted, however, that the scope of the present invention is not limited to details of the preferred embodiments. It is needles to say that a variety of changes and modifications can be made to the embodiments without departing from the essentials of the present invention.

As described above, when the clock-switching control circuit 10 switches the clock signal of the external-bus interface control circuit 9, for example, the execution of instructions by the CPU 8 is suspended. It should be noted that the present invention is not limited to this scheme. If the operations of the CPU and the cache memory are not affected by the operation to switch the clock signal in the bus-state controller, it is not necessary to execute control to suspend and resume execution of instructions by the CPU 8. In addition, the microprocessor is not required to have a function to output synchronous clock signals for external devices. In this case, however, the microprocessor must input synchronous clock signals for external devices from an external source. In addition, the microprocessor can be a device such as a graphic processor customized for specific data processing.

Furthermore, the above description is focused on 2 signals each serving as an external-device select signal, namely, the first and second external-device select signals. It is needles to say, however, that the present invention can be applied to control of switching the frequency of a synchronous clock signal of a bus-interface control signal for three or more external-device select signals.

Effects of representative inventions disclosed in this specification are described briefly as follows.

Clock signals each having a required frequency are provided individually to low-speed and high-speed devices accessed by a microprocessor through separate clock wires. Since control is executed to switch a synchronous clock signal of an external-bus-interface control circuit embedded in the microprocessor in accordance with an external device or an address area being accessed by the microprocessor, there is exhibited an effect of easy clock control in an operation to switch the external device to be accessed from one to another without the need to switch the clock signal itself which is to be supplied to the external device.

What is claimed is:

1. A microprocessor built on a semiconductor chip comprising:
a central processing unit for executing instructions; and
an external bus interface control circuit which controls an external bus on the basis of execution of instructions by said central processing unit,
wherein said external bus interface control circuit is capable of selecting one of a plurality of external device select signals corresponding to an external access address and activating said selected external device select signal, and
wherein said microprocessor further comprises a clock switching control circuit for controlling an operation to switch a synchronous clock signal of said external bus interface control circuit in accordance with said external device select signal activated by said external bus interface control circuit.

2. A microprocessor comprising:
a central processing unit for executing instructions; and
an external bus interface control circuit which controls an external bus on the basis of execution of instructions by said central processing unit,
wherein said external bus interface control circuit is capable of activating either a first external device select signal or a second external device select signal corresponding to an external access address, and
wherein said microprocessor comprises a clock switching control circuit for controlling an operation to switch a synchronous clock signal of said external bus interface control circuit to a first clock signal in accordance with activation of said first external device select signal or to a second clock signal in accordance with activation of said second external device select signal.

3. A microprocessor according to claim 2,
wherein said microprocessor further comprises a clock pulse generator and clock output pins,
wherein said clock pulse generator generates said first clock signal and said second clock signal with a period equal to a predetermined multiple of the period of said first clock signal where said predetermined multiple is defined as a quantity equal to a frequency-division ratio, and
wherein said clock output pins supply respectively said first and second clock signals generated by said clock pulse generator in parallel to respectively outside.

4. A microprocessor comprising:
a central processing unit for executing instructions; and
an external bus interface control circuit controlling an external bus on the basis of execution of instructions by said central processing unit,
wherein said external bus interface control circuit is capable of activating either a first external device select signal or a second external device select signal corresponding to an external access address,
wherein said microprocessor further comprises a clock switching control circuit,
wherein said clock switching control circuit is capable of controlling to switch said synchronous clock signal of said external bus interface control circuit to said first clock signal as well as switch a synchronous clock signal of said central processing unit to a third clock signal in response to activation of said first external device select signal, and is capable of controlling to switch said synchronous clock signal of said external bus interface control circuit to said second clock signal as well as switch said synchronous clock signal of said central processing unit to a fourth clock signal in response to activation of said second external device select signal.

5. A microprocessor according to claim 4,
wherein said microprocessor further comprises a clock pulse generator and clock output pins,
wherein said clock pulse generator generates said first clock signal, said second clock signal with a period equal to a predetermined multiple of the period of said first clock signal where said predetermined multiple is defined as a quantity equal to a frequency-division ratio, said third clock signal and said fourth clock signal with a period equal to another predetermined multiple of the period of said third clock signal where said other predetermined multiple is defined as a quantity equal to another frequency-division ratio,
wherein said clock output pins output respectively said first and second clock signals generated by said clock pulse generator to respectively outside said semiconductor chip, and
wherein said each of frequencies of said third and fourth clock signals is that of said first clock signal.

6. A microprocessor according to claim 2,
wherein said clock switching control circuit requests said central processing unit to suspend execution of instructions in response to activation of a selected external device select signal, and
wherein said clock switching control circuit is further capable of controlling to switch said clock signal after an acknowledgment of a request for suspending of said instruction execution.

7. A microprocessor according to claim 6 wherein said clock switching control circuit is capable of controlling to switch said clock signal at a timing synchronized with periods of said second clock signal.

8. A semiconductor module on a module substrate including a plurality of external connection electrodes and a plurality of wiring layers comprising:
a processor chip; and
a memory chip operating synchronously with a first clock signal,
wherein said microprocessor chip includes a clock pulse generator for generating said first clock signal and a second clock signal with a frequency lower than that of said first clock signal and for supplying in parallel said first and second clock signals to outside,
wherein said microprocessor chip is capable of making an access to said memory chip synchronously with said first clock signal, and
wherein said microprocessor chip is capable of making an external access to outside of said microprocessor chip through one of external connection electrodes synchronously with said second clock signal.

9. A semiconductor module according to claim 8,
wherein said microprocessor chip comprises:
a central processing unit for executing instructions; and
an external bus interface control circuit for controlling an external bus on the basis of execution of an instruction by said central processing unit,
wherein said central processing unit and said external bus interface control circuit are built in a single chip,
wherein said external bus interface control circuit is capable of activating a memory chip select signal for selecting said memory chip in response to an external access address and an external device select signal for selecting a device connected to said microprocessor chip through one of said external connection electrodes,
wherein said microprocessor chip comprises a clock switching control circuit,
wherein said clock switching control circuit is capable of controlling to switch a synchronous clock signal of said external bus interface control circuit to a first clock signal in response to activation of said memory chip select signal, or is capable of controlling to switch said synchronous clock signal of said external bus interface control circuit to a second clock signal in response to activation of said device select signal.

10. A data-processing system comprising:
a first clock wire for transferring a first clock signal;
a second clock wire for transferring a second clock signal with a frequency lower than said first clock signal;
a first device operating synchronously with said first clock signal applying through said first clock wire;
a second device operating synchronously with said second clock signal; and
a third device capable of controlling accesses to said first device synchronously with said first clock signal and capable of controlling accesses to said second device synchronously with said second clock signal,
wherein said first clock wire, said second clock wire, said first device, said second device and said third device are provided on a mounting board.

11. A data-processing system according to claim 10 wherein said mounting board comprises:
a first circuit board including a first board wire connected to said second device; and
a second circuit board including a second board wire connected to said first board wire and said second board wire is connected to said first device and a third device.

12. A data-processing system according to claim 10,
wherein said third device is a microprocessor on a single semiconductor chip comprising a central processing unit for executing instructions, an external bus interface control circuit for controlling an external bus on the basis of execution of instructions by said central processing unit,
wherein said external bus interface control circuit is capable of activating a first external device select signal for selecting said first device or a second external device select signal for selecting said second device in accordance with an external access address,
wherein said third device further includes a clock switching control circuit, and
wherein said clock switching control circuit is capable of controlling to switch a synchronous clock signal of said external bus interface control circuit to a first clock signal in response to activation of said first external device select signal, or is capable of controlling to switch said synchronous clock signal of said external bus interface control circuit to a second clock signal in response to activation of said second external device select signal.

13. A data-processing system according to claim 12,
wherein said third device further comprises a clock pulse generator and clock output pins,
wherein said clock pulse generator applies said first clock signal and said second clock signal with a period equal to a predetermined multiple of the period of said first clock signal where said predetermined multiple is defined as a quantity equal to a frequency-division ratio, and
wherein said clock output pins applies respectively said first and second clock signals generated by said clock pulse generator in parallel to outside said semiconductor chip.

14. A microprocessor according to claim 4,
wherein said clock switching control circuit requests said central processing unit to suspend execution of instructions in response to activation of a selected external device select signal, and
wherein said clock switching control circuit is further capable of controlling to switch said clock signal after an acknowledgment of request for suspending of said instruction execution.
